(19) United States
(12) Patent Application Publication
(10) Pub. No.: US 2020/0118082 A1
(43) Pub. Date: Apr. 16, 2020

(54) Presentation of Credible and Relevant Job History

(71) Applicant: Metabyte Inc., Fremont, CA (US)

(72) Inventors: Manu Mehta, Fremont, CA (US); Yiu Wan Lau, Pacheco, CA (US); Lynn Randolph Slater, Pleasanton, CA (US); Nitin Mehta, Fremont, CA (US); Anjali Dayal, Pleasanton, CA (US); Saiba Singh, Pleasanton, CA (US); Aradhana Mehta, Fremont, CA (US)

(73) Assignee: Metabyte Inc., FREMONT, CA (US)

(21) Appl. No.: 16/600,473

(22) Filed: Oct. 12, 2019

Related U.S. Application Data
(60) Provisional application No. 62/744,665, filed on Oct. 12, 2018.

(51) Int. Cl. G06Q 10/10; G06F 16/2457

(52) U.S. Cl. CPC G06Q 10/1053; G06F 16/24573

(57) ABSTRACT

A method and a credible and relevant job seeker display system (CARJSDS) are provided. The CARJSDS renders the most credible and relevant information about a job seeker with or without regard to a job opportunity. The rendered credible and relevant information includes numerical scores determining a degree of match between a job seeker and a job opportunity; job seeker highlights, job seeker skills and attributes, job seeker job experience summaries, job seeker resumes, other additional documents, and job seeker bibliographic data such as location information, photo, and educational history on a graphical user interface of the reviewer's device to provide a meaningful insight to the reviewer during a job selection process.

### CROSS-REFERENCE TO RELATED APPLICATIONS

This application claims priority to and the benefit of the non-provisional patent application No. 62/744,665, titled “Presentation Of Credible And Relevant Job History”, filed in United States Patent and Trademark Office on Oct. 12, 2018. The specification of the above referenced patent application is incorporated herein by reference in its entirety.

### BACKGROUND

The process of selecting a candidate for a job typically involves receiving and considering resumes submitted by the candidate. These resumes often contain irrelevant information and inaccurate information. This makes the consideration of these resumes tedious and inaccurate. The axiom “garbage in, garbage out” frequently describes the results. The resumes are also cluttered. Even when considering the best available resume, it may be unclear to the reviewer why that resume is a good choice for consideration.

Further, resumes in their traditional form are not always used. In some systems, job seekers may enter job experiences and skills directly into the system without submitting a resume. When matched with a job opportunity, the job seeker becomes a candidate. Even in these scenarios, it may not be clear to a reviewer why the information of one candidate is better for consideration for a job than the information of another candidate.

A reviewer of the resumes will most often be interested to know whether the candidate has the skills the job requires, and to read summaries of the job experiences where these skills were acquired. The reviewer would also like to know if the claimed skills and job summaries are accurate. Skills and job summaries not known to be accurate might still be considered, but with reservation and perhaps with extra probing should the candidate ever be further considered. Skills not relevant to the job and job experiences that did not contribute toward skills relevant to the job might be considered, but only as background information for the most promising candidates.

In some advanced systems, attributes describing the skills a job seeker possesses may be known with varying degrees of proficiency and varying degrees of credibility. Additional non-skill related attributes, such as “citizenship” and “distance from office”, might also be known. These attributes might be collected from third-party sources such as official records, or might be gathered by an operational system. The attributes claimed by the job seeker may also, in some cases, be derived from ratings entered by reviewers. The attributes may also be in a hierarchy, i.e., the attributes may have sub-attributes.

In some advanced systems, job opportunities can be associated with attributes an appropriate candidate is expected to have, and with a measure of the degree to which a candidate should have those attributes. These attributes can also be associated with an importance, such as a need for the attribute “Skilled in PHP” being more important than a need for the attribute “Skilled in MSWord”.

In some advanced systems, attributes describing a job may be known with varying degrees of presence and varying degrees of credibility. These attributes might be collected from third-party sources such as official records, or might be gathered by an operational system. Some attributes associated with a job, such as “nice place to work” may be derived from ratings entered by reviewers. The attributes may also be in a hierarchy, i.e., the attributes may have sub-attributes.

In some advanced systems, a job seeker may have a separate set of attributes that describe the attributes of the job opportunities they will accept are expected to have, and with a measure of the degree to which a job should have those attributes. These attributes can also be associated with an importance, such as a need for the attribute “Compensation” being more important than a need for the attribute “Health Insurance”.

In some advanced systems, there also exists a preexisting score, i.e., “a score that is a numerical measure of the degree of match between a candidate and a job opportunity”. This score might be assembled from the sub-scores of how well the attributes possessed by the candidate match the attributes needed by a job opportunity, and how well the attributes possessed by a job opportunity match the attributes needed by a candidate. These sub-scores might be assembled from scores of how well each attribute matches.

In some systems, job experience summaries may exist for a job seeker that describe a particular job experience and which, in the resume, typically correspond to a block comprising company information and date range along with a declaration by the job seeker. Many skills a job seeker claims, especially any gathered by ratings, are associated with a job experience summary. For example, CAND_1 gets a 0.8 on PHP because CAND_1 has worked as a PHP developer as described in job experience summary #6. In some systems, the job experience summaries may be associated with an overall plausibility score that is an assessment of believability of the content in the summary but which is not associated with any skill. For example, a rater might agree that a job seeker, say, for example, CAND_1 knows Apple iPhone OS, a mobile operating system developed by Apple Inc, but finds that the CAND_1s claim to have been Steve Jobs best friend to be untrue. In some systems, this plausibility score might be derived from ratings entered by reviewers believed to have knowledge of the job experience. In some systems, this plausibility score might be associated with a credibility score.

In some advanced systems, there also exists job seeker highlights, which are terse phrases describing core things to know about the job seeker, for example, the job seeker is a “Super techie”, “People person”, or “Nobel Prize Winner”.

In some advanced systems, job seekers may be associated with bibliographic information such as location information, photo, and educational history.

In some advanced systems, job seekers may be associated with resumes, which are computer readable primarily textual descriptions of their work history and job skills. In some cases, these resumes may be associated with job experience summaries.

In some advanced systems, job seekers may be associated with other computer readable documents, for example, certifications, work authorizations, or cover letters.

In some advanced systems, job opportunities may be associated with computer readable documents. Examples are job descriptions or company background.

There are two primary times when a reviewer may be considering job seeker information. One is when considering the job seeker overall, such as when considering what business domains might have job opportunities for which this candidate can be a fit. The other is when considering the candidate as a possible fit for a specific job opportunity.

Thus, there exists a need for providing a reviewer, viewing a job seeker's resume, credible information about the job seeker, and more particularly information related to job experiences and skills.

Hence, there is a long felt but unresolved need for a method and a credible and relevant job seeker display system to provide a meaningful insight to the reviewer without regard to a specific job opportunity by displaying job seeker highlights, the most credible attributes of the job seeker, job experience summaries of known plausibility and credibility, resumes, additional documents, and job seeker biographical information including education.

Thus, there exists a need for a reviewer who is looking to fill a job opportunity to know why the reviewer has to consider the candidate and why the candidate has to consider the job opportunity. The second aspect is important because otherwise the reviewer would be wasting his/her time considering the candidate who would later refuse the job.

Hence, there is a long felt but unresolved need for a method and a credible and relevant job seeker display system to provide a meaningful insight to the reviewer of a specific candidate during a job selection process for a specific job opportunity by displaying numerical scores determining a degree of match between a job seeker and a job opportunity; displaying job seeker highlights i.e., highlighting several aspects about the job seeker in the job seeker's resume; displaying the most important and credible attributes of the job seeker, displaying job experience summaries of known plausibility and credibility, displaying resumes; displaying additional documents, and displaying job seeker biographical information including education.

### SUMMARY OF THE INVENTION

This summary is provided to introduce a selection of concepts in a simplified form that are further disclosed in the detailed description of the invention. This summary is not intended to determine the scope of the claimed subject matter.

The method and the system disclosed herein address the above recited need for providing a credible and relevant job seeker display system (CARJSDS) for rendering the most credible and relevant information about a job seeker with or without respect to a job opportunity. The credible and relevant information includes numerical scores for determining a degree of match between a job seeker and a job opportunity, job seeker highlights, job seeker skills and attributes, job seeker job experience summaries, job seeker resumes, job seeker documents, and job seeker biographic data to provide a meaningful insight to the reviewer during a job selection process.

The credible and relevant job seeker display system (CARJSDS) for rendering the most credible and relevant information about a job seeker with or without respect to a job opportunity comprises at least one computer server for rendering a credible and relevant information about a job seeker with respect to a job opportunity. The at least one computer server of the credible and relevant job seeker display system (CARJSDS) comprises at least one database server and at least one processing computer server. The database server of the credible and relevant job seeker display system (CARJSDS) hosts one or more databases for storing a predefined attribute list, an attributes possessed list, an attributes needed list, a need match attribute list, a job experience summary data, an overall match score representing a degree of match for a job seeker profile and a job opportunity profile, job opportunity need scores, job seeker need score, a list of job seeker job experience summaries linked to said attributes possessed list, resumes, other documents, and job seeker bibliographic information such as location information, photo, and educational history.

The processing computer server of the credible and relevant job seeker display system (CARJSDS) comprises at least one processor communicatively coupled to the database server via a network. The processor is configured to execute the computer program instructions defined by modules of the credible and relevant job seeker display system (CARJSDS). The modules of the credible and relevant job seeker display system (CARJSDS) comprise a first predefined attribute list receiving module, a needs attributes list receiving module, an overall match score receiving module, a first list receiving module, and a first rendering module.

The first predefined attribute list receiving module of the credible and relevant job seeker display system (CARJSDS) receives the predefined attribute list. The attributes possessed list comprises attributes present, hierarchical sub-attributes of each of the attributes present in the job seekers profiles and job opportunity profiles. The first predefined attribute list receiving module of the credible and relevant job seeker display system (CARJSDS) further comprises amount present measures and credibility measures indicating the credibility of the corresponding amount present measures. The needs attributes list receiving module of the credible and relevant job seeker display system (CARJSDS) receives the need attributes list. The needs attributes list comprises attributes needed, hierarchical sub-attributes of each of the attributes needed in the job seeker profile and job opportunity profiles. The needs attributes list receiving module of the credible and relevant job seeker display system (CARJSDS) further comprises amount needed measures and credibility measures indicating the importance of the corresponding amount needed measures.

The overall match score receiving module of the credible and relevant job seeker display system (CARJSDS) receives the overall match score representing the degree of match for each of the job seeker profiles and the job opportunity profiles. The job opportunity need scores, the job seekers need scores, and an attribute matched list comprise attributes needed matched to attributes present. The first list receiving module of the credible and relevant job seeker display system (CARJSDS) receives the list of job seeker job experience summaries, job seeker resumes and other additional documents and job seeker bibliographic information such as location information, photo, and educational history.

The first rendering module of the credible and relevant job seeker display system (CARJSDS) renders the most credible and relevant information about the job seeker with respect to the job opportunity, for the job seeker matched with the job opportunity. The first rendering module of the credible and relevant job seeker display system (CARJSDS) further comprises a job opportunity need score rendering module, a job seeker need score rendering module, an attribute rendering module, a job experience summary rendering module, a highlight option rendering module, and a list rendering module. The job opportunity need score rendering module of the credible and relevant job seeker display system (CARJSDS) renders the job opportunity need score representing the degree of match between the attributes needed, hierarchical sub-attributes of each of the attributes needed by the job opportunity profile with the attributes possessed, and hierarchical sub-attributes of each of the attributes possessed by the job seeker profile.

The job seeker need score rendering module of the credible and relevant job seeker display system (CARJSDS) renders the job seeker need score representing the degree of match between the attributes needed, hierarchical sub-attributes of each of the attributes needed by the job seekers profile with the attributes possessed, hierarchical sub-attributes of each of the attributes possessed by the job opportunity profile. The attribute rendering module of the credible and relevant job seeker display system (CARJSDS) renders a list of top N attributes from the attributes matched list that most strongly contributed to the job opportunity need score. The job experience summary rendering module of the credible and relevant job seeker display system (CARJSDS) renders a list of top job experience summaries whose rated attributes contributed to the job opportunity need score. The highlight option rendering module of the credible and relevant job seeker display system (CARJSDS) renders a highlight option displaying a list of core points to know about a candidate. The list rendering module of the credible and relevant job seeker display system (CARJSDS) renders the list of job seeker resumes, the list of job seeker other documents, the job seeker bibliographic information such as location information, photo, and educational history on the graphical user interface of the reviewer's device to provide a meaningful insight to the reviewer during a job selection process.

The credible and relevant job seeker display system (CARJSDS) further comprises a second predefined attribute list receiving module, a second list receiving module, and a second rendering module. The second predefined attribute list receiving module of the credible and relevant job seeker display system (CARJSDS) receives the predefined attribute list. The attributes possessed list comprising attributes present, hierarchical sub-attributes of each of the attributes present in the job seekers profile. The second list receiving module of the credible and relevant job seeker display system (CARJSDS) receives the list of job seeker job experience summaries, the job seeker skills and attributes, the job seeker resumes and job seeker other documents, the job seeker bibliographic information such as location information, photo and educational history. The second rendering module of the credible and relevant job seeker display system (CARJSDS) renders the most credible information about the job seeker without regard to the job opportunity comprising the job seeker highlights, the job seeker skills and attributes, the job seeker job experience summaries, the job seeker resumes, the job seeker documents, and job seeker biographic data to provide the meaningful insight to the reviewer during the job selection process. The credible and relevant job seeker display system (CARJSDS) further comprises a rating link provider for providing an additional rating link information along with the rendered list of matched attributes when the matched attributes has its value present measure preset through ratings. The rating link information comprises number of ratings, individual rating information and identities of the rater who provided the rating information.

The method disclosed herein employs a credible and relevant job seeker display system (CARJSDS) incorporating a computer system architecture comprising at least one computer server. The computer server comprises at least one database server and at least one processing computer server. The database server hosts one or more databases for storing a predefined attribute list, an attributes possessed list, an attributes needed list, a need match attribute list, an overall match score representing a degree of match for a job seeker profile and a job opportunity profile, job opportunity need score, job seeker need score, a list of job seeker job experience summaries linked to the attributes possessed list, resumes, other documents, and job seeker bibliographic information such as location information, photo, educational history. The processing computer server is configured to execute the computer program instructions defined by modules of the credible and relevant job seeker display system (CARJSDS) for rendering a degree of match between job seeker profile and job opportunity profile on a graphical user interface of the users device. The user may be a reviewer of a job opportunity profile, and a job seeker profile.

In the method disclosed herein, the credible and relevant job seeker display system (CARJSDS) receives a predefined attribute list, an attributes possessed list comprising attributes present, hierarchical sub-attributes of each of the attributes present in the job seeker profile and the job opportunity profile. The attributes possessed list and the hierarchical sub-attributes of each of the attributes possessed list comprises amount present measures and credibility measures indicating the credibility of the corresponding amount present measures. The credible and relevant job seeker display system (CARJSDS) also receives a need attributes list comprising attributes needed, hierarchical sub-attributes of each of the attributes needed in the job seeker profile and the job opportunity profile. The attributes needed and the hierarchical sub-attributes of each of the attributes needed in the job seeker profile and the job opportunity profile comprises amount needed measures and importance measures indicating the importance of the corresponding amount needed measures.

The credible and relevant job seeker display system (CARJSDS) also receives an overall match score representing a degree of match for each of the job seeker profiles and the job opportunity profiles, job opportunity need score, job seeker need score, and an attribute matched list comprising attributes needed matched to attributes present. The attributes matched list and the hierarchical sub-attributes of each of the attributes matched list comprises match scores indicating the degree of match between the attributes needed and the attributes possessed. The credible and relevant job seeker display system (CARJSDS) also receives a list of job seeker job experience summaries which may link to job seeker attributes possessed. The credible and relevant job seeker display system (CARJSDS) also receives job seeker highlights, job seeker resumes and other additional documents, and job seeker bibliographic information such as location information, photo, and educational history.

In an embodiment, the credible and relevant job seeker display system (CARJSDS) renders for a job seeker matched with a job opportunity an overall match score, an opportunity need score, a job seekers need score, job seeker highlights, a list of top attributes, a list of top job seeker job experience summaries, a list of job seeker resumes, a list of job seeker other documents, job seeker bibliographic information such as location information, photo, and educational history on a graphical user interface of the reviewers device. The CARJSDS system renders a list of the top N job experience summaries along with plausibility measures and corresponding experience credibility measures, and the entire list of job experience summary is displayed as a pop-up or using a link. Thus, when the job seeker is matched with a job opportunity, the job experience summaries are sorted by the rated attributes that contributed to the job opportunity need match score, with job experience plausibility and job experience end date as secondary sorting factors.

The rendered opportunity overall match score represents the degree of match between the job seeker profile and the job opportunity profile. This is a combination of the job opportunity need score and the job seeker need score. The rendered opportunity need score represents the degree of match between the attributes needed, hierarchical sub-attributes of each of the attributes needed by the job opportunity profile with the attributes possessed, and hierarchical sub-attributes of each of the attributes possessed by the job seekers profile. The rendered job seeker's need score represents the degree of match between the attributes needed, hierarchical sub-attributes of each of the attributes needed by the job seekers profiles with the attributes possessed, hierarchical sub-attributes of each of the attributes possessed by the opportunity profile.

The credible and relevant job seeker display system (CARJSDS) allows the reviewer to click on the rendered job opportunity need score to view the list of matched attributes along with a value present measure, credibility measure arranged in the hierarchy of the need attributes importance measure. In a similar manner, the CARJSDS system displays a list of attributes matched that contributed to the job seekers need score along with a value present measure, credibility measure arranged in the hierarchy of the need attributes importance measure on clicking on the job seeker's need score.

In an embodiment, the credible and relevant job seeker display system (CARJSDS) also provides additional rating information along with the rendered list of matched attributes when the matched attributes has its value present measure preset through ratings. The rating link information shows ratings information including number of ratings, individual rating information and identities of the rater who provided the rating information. The CARJSDS also provides individual rating information and identities of the rater who provided the rating information upon authorization. Further, when the job seeker is matched with a job opportunity, the rendered list of attributes is the top N attributes from the attributes matched list that most strongly contributed to the job opportunity need score. The match score is shown along with an indication of the score's credibility. In an embodiment, the overall match score, opportunity need score, and job seeker's need score are not rendered by the CARJSDS, i.e., when the job seeker is not matched with a job opportunity, the CARJSDS renders a list of top N attributes with the highest credibility weighted amount present measure from the job seeker's attributes possessed list. In a similar manner, the CARJSDS system renders job experience summaries sorted by job experience plausibility and job experience end date.

The CARJSDS system renders a list of top N job seeker resumes with a button or link to display the entire list of job seeker resumes. The rendered top N job seeker resumes are sorted by those that linked to the most highly sorted job experience summaries, with document date as a secondary sorting factor. The CARJSDS system renders a list of top N job seeker additional documents with a button or link that causes to display the entire list of the job seeker additional documents. The additional documents are sorted by name, with document date as a secondary sorting factor.

Thus, the credible and relevant job seeker display system (CARJSDS) through the rendered overall match score, opportunity need score, job seekers need score, job seeker highlights, list of top attributes, list of top job seeker job experience summaries, list of job seeker resumes, list of job seeker associated documents, and job seeker bibliographic information presents the job seekers information with a validated job experience summary and validated skills based approach, sorted by relevance to the matched job when present, thereby allowing an easy to quickly scan format in the GUI of the reviewer's device. A reviewer might first look at the match score, then for the best candidates they might look at the most important validated skills and attributes, and the most relevant job experiences that contributed to those skills along with a plausibility measure of the job summary data. The most important and validated information is prominent, while the less relevant or invalidated information will take deeper examination to find.

Further, the credible and relevant job seeker display system also provides a meaningful insight to the reviewer without regard to a specific job opportunity by displaying job seeker highlights, the most credible attributes of the job seeker, job experience summaries of known plausibility and credibility, resumes, additional documents, and job seeker biographical information including location information, photo and educational history.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein.

FIG. 1 exemplarily illustrates a credible and relevant job seeker display system incorporating a computer system architecture for rendering a credible and relevant information about a job seeker with respect to a job opportunity.

FIG. 2A illustrates a method for displaying the most credible and relevant information about a job seeker with respect to a job opportunity.

FIG. 2B illustrates a method for displaying the most credible and relevant information about a job seeker.

FIGS. 3A-3C exemplarily illustrate an attributes possessed list comprising attributes possessed in the item profiles CAND_1, CAND_2, and CAND_3, JOB_1 and JOB_2 with corresponding value present measures and credibility measures.

FIG. 4 exemplarily illustrates an attributes needed list comprising attributes needed in the JOB profile JOB_1 with corresponding requirement measures, attribute importance measures, and value needed measures.

FIG. 5 exemplarily illustrates the attributes possessed list comprising attributes possessed by the CAND_L with corresponding value present measures and credibility measure.

FIGS. 6A and 6B exemplarily illustrates a matched attribute list created by the CARJSDS system by matching the attributes possessed in the attributes possessed list with the attributes needed in the attributes needed list.

FIG. 7 exemplarily illustrates a screenshot of a graphical user interface rendered on a reviewer's device by the credible and relevant job seeker display system (CARJSDS).

### DETAILED DESCRIPTION OF THE INVENTION

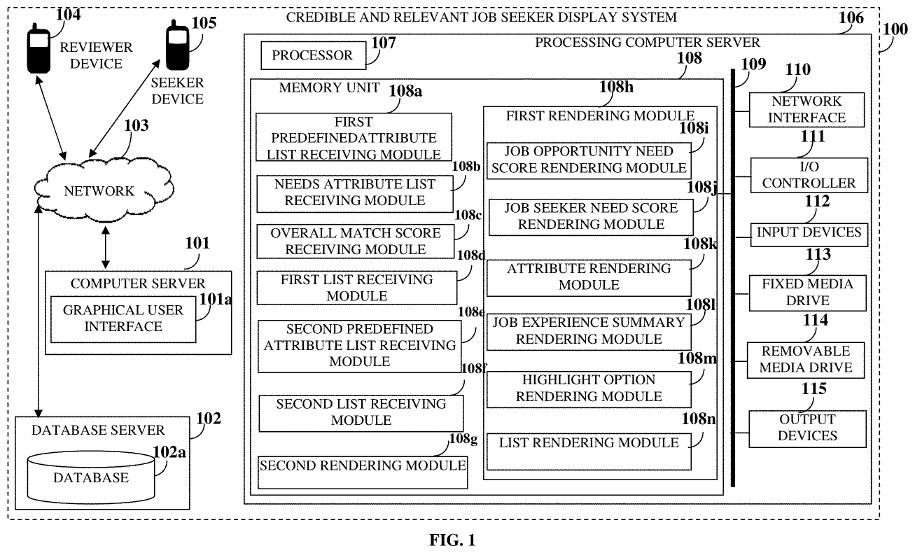

FIG. 1 exemplarily illustrates a credible and relevant job seeker display system (CARJSDS) 100 incorporating a computer system architecture for rendering a credible and relevant information about a job seeker with respect to a job opportunity. The credible and relevant job seeker display system (CARJSDS) 100 is a computer system that is programmable using a high level computer programming language. In an embodiment, the credible and relevant job seeker display system (CARJSDS) 100 uses programmed and purposeful hardware. The credible and relevant job seeker display system (CARJSDS) 100 is implemented on a computing device, for example, a personal computer, a tablet computing device, a mobile computer, a portable computing device, a laptop, a touch device, a workstation, a server, portable electronic device, a network enabled computing device, an interactive network enabled communication device, any other suitable computing equipment, combinations of multiple pieces of computing equipment, etc. In an embodiment, the computing equipment is used to implement applications such as media playback applications, a web browser, an electronic mail (email) application, a calendar application, etc. In another embodiment, the computing equipment, for example, one or more servers are associated with one or more online services. In an embodiment, the credible and relevant job seeker display system (CARJSDS) 100 is configured as a web based platform, for example, a website hosted on a server or a network of servers.

The credible and relevant job seeker display system ((CARJSDS)) 100 comprises at least one computer server 101, at least one database server 102, and at least one processing computer server 106. The computer server 101 renders graphical user interfaces 101a to multiple seeker devices 105 and multiple reviewer devices 104. As used herein, “seeker devices” and “reviewer devices” are user devices, for example, personal computers, laptops, tablet computing devices, mobile computers, mobile phones, smartphones, portable computing devices, personal digital assistants, laptops, wearable computing devices such as the Google Glass® of Google Inc., the Apple Watch® of Apple Inc., etc., touch centric devices, workstations, client devices, portable electronic devices, network enabled computing devices, interactive network enabled communication devices, any other suitable computing equipment, combinations of multiple pieces of computing equipment, etc., possessed by the opportunity seekers and the reviewers respectively, for interacting with the CARJSDS 100. In an embodiment, the seeker devices 105 and reviewer devices 104 are hybrid computing devices that combine the functionality of multiple devices. Examples of a hybrid computing device comprise a cellular telephone that includes a media player functionality, a gaming device that includes a wireless communications capability, a cellular telephone that includes a document reader and multimedia functions, and a portable device that has network browsing, document rendering, and network communication capabilities. For purposes of illustration, the seeker devices 105 and reviewer devices 104 are user devices of a recruitment system of entities such as offices, educational institutes, etc.

The processing computer server 106 comprising at least one processor is communicatively coupled to the database server 102 via a network 103. The network is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the credible and relevant job seeker display system (CARJSDS) 100 is accessible to the satellite internet of users, for example, through a broad spectrum of technologies and devices such as cellular phones, tablet computing devices, etc., with access to the internet.

As exemplarily illustrated in FIG. 1, the credible and relevant job seeker display system (CARJSDS) 100 comprises a non-transitory computer readable storage medium, for example, a memory unit 108 for storing programs and data, and at least one processor 107 communicatively coupled to the non-transitory computer readable storage medium. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 107. The non-transitory computer readable storage medium is configured to store computer program instructions defined by modules, for example, 108a, 108b, 108c, 108d, 108e, 108f, 108g, 108h, 108i, 108j, 108k, 108l, 108m, 108n, etc., of the credible and relevant job seeker display system (CARJSDS) 100. The modules 108a, 108b, 108c, 108d, 108e, 108f, 108g, 108h, 108i, 108j, 108k, 108l, 108m, 108n are installed and stored in the memory unit 108 of the credible and relevant job seeker display system (CARJSDS) 100. The memory unit 108 is used for storing program instructions, applications, and data. The memory unit 108 is, for example, a random access memory (RAM) or another type of dynamic storage device that stores information and instructions for execution by the processor 107. The memory unit 108 also stores temporary variables and other intermediate information used during execution of the instructions by the processor 107. The credible and relevant job seeker display system (CARJSDS) 100 further comprises a read only memory (ROM) or another type of static storage device that stores static information and instructions for the processor 107.

The processor 107 is configured to execute the computer program instructions defined by the modules, for example, 108a, 108b, 108c, 108d, 108e, 108f, 108g, 108h, 108i, 108j, 108k, 108l, 108m, 108n etc., of the credible and relevant job seeker display system (CARJSDS) 100. The processor 107 refers to any of one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 107 is implemented as a processor set comprising, for example, a programmed microprocessor and a math or graphics co-processor. The processor 107 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The credible and relevant job seeker display system (CARJSDS) 100 disclosed herein is not limited to employing a processor 107. In an embodiment, the credible and relevant job seeker display system (CARJSDS) 100 employs a controller or a microcontroller.

As exemplarily illustrated in FIG. 1, the credible and relevant job seeker display system (CARJSDS) 100 further comprises a data bus 109, a network interface 110, an input/output (I/O) controller 111, input devices 112, a fixed media drive 113 such as a hard drive, a removable media drive 114 for receiving removable media, output devices 115, etc. The data bus 109 permits communications between the modules, for example, 108a, 108b, 108c, 108d, 108e, 108f, 108g, 108h, 108i, 108j, 108k, 108l, 108m, 108n etc., of the credible and relevant job seeker display system (CARJSDS) 100. The network interface 110 enables connection of the credible and relevant job seeker display system (CARJSDS) 100 to the network 103. In an embodiment, the network interface 110 is provided as an interface card also referred to as a line card. The network interface 110 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on a transmission control protocol (TCP)/internet protocol (IP), interfaces based on wireless communications technology such as satellite technology, radio frequency (RF) technology, near field communication, etc. The I/O controller 111 controls input actions and output actions performed by the credible and relevant job seeker display system (CARJSDS) 100.

The display screen, via the graphical user interface (GUI) 101a, displays credible and relevant information about a job seeker with respect to a job opportunity. The display screen is, for example, a video display, a liquid crystal display, a plasma display, an organic light emitting diode (OLED) based display, etc. The credible and relevant job seeker display system (CARJSDS) 100 provides the GUI 101a on the display screen. The GUI 101a is, for example, an online web interface, a web based downloadable application interface, a mobile based downloadable application interface, etc. The display screen displays the GUI 101a. The input devices 112 are used for inputting data into the credible and relevant job seeker display system (CARJSDS) 100. The input devices 112 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. The output devices 115 output the results of operations performed by the credible and relevant job seeker display system (CARJSDS) 100.

The at least one computer server 101 of the credible and relevant job seeker display system (CARJSDS) 100 comprises at least one database server 102, and at least one processing computer server 106. The at least one database server 102 of the credible and relevant job seeker display system (CARJSDS) 100 hosts one or more databases 102a for storing a predefined attribute list, an attributes possessed list, an attributes needed list, a need match attribute list, a job experience summary data, an overall match score representing a degree of match for a job seeker profile and a job opportunity profile, job opportunity need scores, job seeker need score, a list of job seeker job experience summaries linked to the attributes possessed list, resumes, associated documents, and job seeker bibliographic information such as location information, photo, and educational history. As used herein, associated documents comprise work authorizations, certifications, description of one or more company benefits, references, appreciation letters, etc.

The modules of the credible and relevant job seeker display system (CARJSDS) 100 comprise a first predefined attribute list receiving module 108a, a needs attributes list receiving module 108b, an overall match score receiving module 108c, a first list receiving module 108d, a first rendering module 108h. The first predefined attribute list receiving module 108a of the credible and relevant job seeker display system (CARJSDS) 100 receives the predefined attribute list. The attributes possessed list comprise attributes present, hierarchical sub-attributes of each of the attributes present in the job seekers profiles and job opportunity profiles. The first predefined attribute list receiving module 108a of the credible and relevant job seeker display system (CARJSDS) 100 further comprises amount present measures and credibility measures indicating credibility of the corresponding amount present measures. The needs attributes list receiving module 108b of the credible and relevant job seeker display system (CARJSDS) 100 receives the need attributes list. The needs attributes list comprise attributes needed, hierarchical sub-attributes of each of the attributes needed in the job seeker profile and job opportunity profiles. The needs attributes list receiving module 108b of the credible and relevant job seeker display system (CARJSDS) 100 further comprises amount needed measures and credibility measures indicating importance of the corresponding amount needed measures. The overall match score receiving module 108c of the credible and relevant job seeker display system (CARJSDS) 100 receives the overall match score representing the degree of match for each of the job seeker profiles and the job opportunity profiles, the job opportunity need scores, the job seekers need scores, and an attribute matched list comprising attributes needed matched to attributes present.

The first list receiving module 108d of the credible and relevant job seeker display system (CARJSDS) 100 receives the list of job seeker job experience summaries, job seeker resumes and other additional documents and job seeker bibliographic information such as location information, photo, and educational history. The first rendering module 108h of the credible and relevant job seeker display system (CARJSDS) 100 renders the most credible and relevant information about the job seeker with respect to the job opportunity, for the job seeker matched with the job opportunity. The first rendering module 108h of the credible and relevant job seeker display system (CARJSDS) 100 further comprises a job opportunity need score rendering module 108i, a job seeker need score rendering module 108j, an attribute rendering module 108k, a job experience summary rendering module 108l, a highlight option rendering module 108m, and a list rendering module 108n.

The job opportunity need score rendering module 108l of the credible and relevant job seeker display system (CARJSDS) 100 renders the job opportunity need score representing degree of match between the attributes needed, hierarchical sub-attributes of each of the attributes needed by the job opportunity profile with the attributes possessed, hierarchical sub-attributes of each of the attributes possessed by the job seeker profile. The job seeker need score rendering module 108j of the credible and relevant job seeker display system (CARJSDS) 100 renders the job seeker need score representing the degree of match between the attributes needed, hierarchical sub-attributes of each of the attributes needed by the job seekers profile with the attributes possessed, hierarchical sub-attributes of each of the attributes possessed by the job opportunity profile.

The attribute rendering module 108k of the credible and relevant job seeker display system (CARJSDS) 100 renders a list of top N attributes from the attributes matched list that most strongly contributed to the job opportunity need score. The job experience summary rendering module 108l of the credible and relevant job seeker display system (CARJSDS) 100 renders a list of top job experience summaries whose rated attributes contributed to the job opportunity need score. The highlight option rendering module 108m of the credible and relevant job seeker display system (CARJSDS) 100 renders a highlight option displaying a list of core points to know about a candidate. In an embodiment, the highlight option rendering module 108m is configured to display a brief list of the core points. The list rendering module 108n of the credible and relevant job seeker display system (CARJSDS) 100 renders the list of job seeker resumes, the list of job seeker associated documents, the job seeker bibliographic information such as location information, photo, and educational history on the graphical user interface of the reviewer's device 104 to provide a meaningful insight to the reviewer during a job selection process.

The credible and relevant job seeker display system (CARJSDS) 100 further comprises a second predefined attribute list receiving module 108e, a second list receiving module 108f, and a second rendering module 108g. The second predefined attribute list receiving module 108e of the credible and relevant job seeker display system (CARJSDS) 100 receives the predefined attribute list. The attributes possessed list comprising attributes present, hierarchical sub-attributes of each of the attributes present in the job seekers profile. The second list receiving module 108f of the credible and relevant job seeker display system (CARJSDS) 100 receives the list of job seeker job experience summaries, the job seeker skills and attributes, the job seeker resumes and job seeker associated documents, the job seeker bibliographic information such as location information, photo and educational history. The second rendering module 108g of the credible and relevant job seeker display system (CARJSDS) 100 renders the most credible information about the job seeker without regard to the job opportunity comprising, the job seeker highlights, the job seeker skills and attributes, the job seeker job experience summaries, the job seeker resumes, the job seeker documents, and job seeker biographic data to provide said meaningful insight to the reviewer during the job selection process. The credible and relevant job seeker display system (CARJSDS) 100 further comprises a rating link provider for providing an additional rating link information along with the rendered list of matched attributes when the matched attributes has its value present measure preset through ratings. The rating link information comprises number of ratings, individual rating information and identities of the rater who provided the rating information.

In an embodiment, the highlight option rendering module 108m is configured to automatically highlight and display the list of core points about a candidate. In an embodiment, the highlight option rendering module 108m in association with the processor 107 categorizes the core points into distinct categories for displaying on the reviewer device 104. For example, the core points are categorized into athletic skills, educational skills, interpersonal skills, technical skills, top job experiences, etc. The database 102a in the database server 102 of the (CARJSDS) 100 comprises keywords, synonyms, hypernyms, and hyponyms corresponding to each of the categories into which the core points are categorized. The highlight option rendering module 108m in association with the processor 107 reads the list of job seeker job experience summaries, the job seeker resumes, associated documents, and job seeker bibliographic information. The highlight option rendering module 108m compares content in the list of job seeker job experience summaries, the job seeker resumes, associated documents, and job seeker bibliographic information with keywords, synonyms, hypernyms, and hyponyms corresponding to each of the categorized core points. In an embodiment, based on the comparison, the highlight option rendering module 108m identifies the core points to be highlighted in the list of job seeker job experience summaries, the job seeker resumes, associated documents, and job seeker bibliographic information. The highlight option rendering module 108m automatically highlights and displays the list of core points about the candidate. In an embodiment, the highlight option rendering module 108m also displays the category under which a displayed highlighted core point in the list of core points is categorized.

In an embodiment, the highlight option rendering module 108m in association with the processor 107 creates a core point category description for each of the core points to provide a description of the category under which a core point in the list of core points is categorized. In an embodiment, two or more core points are categorized under the same category based on the content in the list of job seeker job experience summaries, the job seeker resumes, associated documents, and job seeker bibliographic information corresponding to the two or more core points. The highlight option rendering module 108m in association with the processor 107 utilizes common keywords to create the core point category description for each of the core points that are categorized under a category. Consider an example of the category “athletic skills” that involves running, jumping and throwing. If the content in the list of job seeker job experience summaries, the job seeker resumes, associated documents, and job seeker bibliographic information comprises swimming, cycling, boxing, etc., as the skills of a candidate named John, the highlight option rendering module 108m in association with the processor 107 uses common keywords, for example, athletics, fast physical movement, etc., to create the core point category description of John. Categorizing the display of the list of core points about a candidate enables the reviewer to quickly access the categories, for example, athletic skills, educational skills, interpersonal skills, technical skills, top job experiences, etc.

The database server 102 of the credible and relevant job seeker display system (CARJSDS) 100 can be any storage area or medium that can be used for storing data and files. In an embodiment, the credible and relevant job seeker display system (CARJSDS) 100 stores the received information in external databases, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the database server 102 can be remotely accessed by the credible and relevant job seeker display system (CARJSDS) 100 via the network 103. In another embodiment, the database server 102 is configured as a cloud based database implemented in a cloud computing environment, where computing resources are delivered as a service over the network 103.

Computer applications and programs are used for operating the modules of the credible and relevant job seeker display system (CARJSDS) 100. The programs are loaded onto the fixed media drive 113 and into the memory unit 108 of the credible and relevant job seeker display system (CARJSDS) 100 via the removable media drive 114. In an embodiment, the computer applications and programs are loaded directly on the credible and relevant job seeker display system (CARJSDS) 100 via the network 103. The processor 107 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., etc. The credible and relevant job seeker display system (CARJSDS) 100 employs the operating system for performing multiple tasks. The operating system is responsible for management and coordination of activities and sharing of resources of the credible and relevant job seeker display system (CARJSDS) 100. The operating system further manages security of the credible and relevant job seeker display system (CARJSDS) 100, peripheral devices connected to the credible and relevant job seeker display system (CARJSDS) 100, and network connections. The operating system employed on the credible and relevant job seeker display system (CARJSDS) 100 recognizes, for example, inputs provided by a user of the credible and relevant job seeker display system (CARJSDS) 100 using one of the input devices 112, the output devices 115, files, and directories stored locally on the fixed media drive 113. The operating system on the credible and relevant job seeker display system (CARJSDS) 100 executes different programs using the processor 107. The processor 107 and the operating system together define a computer platform for which application programs in high level programming languages are written.

The processor 107 of the credible and relevant job seeker display system (CARJSDS) 100 retrieves instructions defined by the first predefined attribute list receiving module 108a, the needs attributes list receiving module 108b, the overall match score receiving module 108c, the first list receiving module 108d, the first rendering module 108h, the job opportunity need score rendering module 108i, the job seeker need score rendering module 108j, the attribute rendering module 108k, the job experience summary rendering module 108l, the highlight option rendering module 108m, the list rendering module 108n, the second predefined attribute list receiving module 108e, the second list receiving module 108f, and the second rendering module 108g for performing respective functions disclosed above. The processor 107 retrieves instructions for executing the modules, for example, 108a, 108b, 108c, 108d, 108e, 108f, 108g, 108h, 108i, 108j, 108k, 108l, 108m, 108n, etc., of the credible and relevant job seeker display system (CARJSDS) 100 from the memory unit 108. A program counter determines the location of the instructions in the memory unit 108. The program counter stores a number that identifies the current position in the program of each of the modules, for example, 108a, 108b, 108c, 108d, 108e, 108f, 108g, 108h, 108i, 108j, 108k, 108l, 108m, 108n etc., of the credible and relevant job seeker display system (CARJSDS) 100. The instructions fetched by the processor 107 from the memory unit 108 after being processed are decoded. The instructions are stored in an instruction register in the processor 107. After processing and decoding, the processor 107 executes the instructions, thereby performing one or more processes defined by those instructions.

At the time of execution, the instructions stored in the instruction register are examined to determine the operations to be performed. The processor 107 then performs the specified operations. The operations comprise arithmetic operations and logic operations. The operating system performs multiple routines for performing a number of tasks required to assign the input devices 112, the output devices 115, and the memory unit 108 for execution of the modules, for example, 108a, 108b, 108c, 108d, 108e, 108f, 108g, 108h, 108i, 108j, 108k, 108l, 108m, 108n, etc., of the credible and relevant job seeker display system (CARJSDS) 100. The tasks performed by the operating system comprise, for example, assigning memory to the modules, for example, 108a, 108b, 108c, 108d, 108e, 108f, 108g, 108h, 108i, 108j, 108k, 108l, 108m, 108n, etc., of the credible and relevant job seeker display system (CARJSDS) 100 and to data used by the credible and relevant job seeker display system (CARJSDS) 100, moving data between the memory unit 108 and disk units, and handling input/output operations. The operating system performs the tasks on request by the operations and after performing the tasks, the operating system transfers the execution control back to the processor 107. The processor 107 continues the execution to obtain one or more outputs. The outputs of the execution of the modules, for example, 108a, 108b, 108c, 108d, 108e, 108f, 108g, 108h, 108i, 108j, 108k, 108l, 108m, 108n, etc., of the credible and relevant job seeker display system (CARJSDS) 100 are displayed to a user of the credible and relevant job seeker display system (CARJSDS) 100 on the output device 115. In an embodiment, one or more portions of the credible and relevant job seeker display system (CARJSDS) 100 are distributed across one or more computer systems (not shown) coupled to the network 103.

The non-transitory computer readable storage medium having embodied thereon, computer program codes comprising instructions executable by at least one processor 107 for rendering a credible and relevant information about a job seeker with respect to a job opportunity. The computer program codes comprise a first computer program code for receiving the predefined attribute list, the attributes possessed list comprising attributes present, hierarchical sub-attributes of each of the attributes present in the job seekers profiles and job opportunity profiles; a second computer program code for receiving the need attributes list comprising attributes needed, hierarchical sub-attributes of each of the attributes needed in the job seeker profile and job opportunity profiles; a third computer program code for receiving the overall match score representing the degree of match for each of the job seeker profiles and the job opportunity profiles, the job opportunity need scores, the job seekers need scores, and an attribute matched list comprising attributes needed matched to attributes present; a fourth computer program code for receiving the list of job seeker job experience summaries, job seeker resumes and other additional documents and job seeker bibliographic information such as location information, photo, and educational history; a fifth computer program code for rendering the most credible and relevant information about the job seeker with respect to the job opportunity, for the job seeker matched with the job opportunity; a sixth computer program code for rendering the job opportunity need score representing degree of match between the attributes needed, hierarchical sub-attributes of each of the attributes needed by the job opportunity profile with the attributes possessed, hierarchical sub-attributes of each of the attributes possessed by the job seeker profile; a seventh computer program code for rendering the job seeker need score representing the degree of match between the attributes needed, hierarchical sub-attributes of each of the attributes needed by the job seekers profile with the attributes possessed, hierarchical sub-attributes of each of the attributes possessed by the job opportunity profile; an eighth computer program code for rendering a list of top N attributes from the attributes matched list that most strongly contributed to the job opportunity need score; a ninth computer program code for rendering a list of top job experience summaries whose rated attributes contributed to the job opportunity need score; a tenth computer program code for rendering a highlight option displaying a list of core points to know about a candidate; and an eleventh computer program code for rendering the list of job seeker resumes, the list of job seeker associated documents, the job seeker bibliographic information such as location information, photo, and educational history on the graphical user interface of the reviewer's device to provide a meaningful insight to the reviewer during a job selection process.

The non-transitory computer readable storage medium further comprise a twelfth computer program code for receiving the predefined attribute list, the attributes possessed list comprising attributes present, hierarchical sub-attributes of each of the attributes present in the job seekers profile; a thirteenth computer program code for receiving the list of job seeker job experience summaries, the job seeker skills and attributes, the job seeker resumes and job seeker associated documents, the job seeker bibliographic information such as location information, photo and educational history; and a fourteenth computer program code for rendering the most credible information about the job seeker without regard to the job opportunity comprising the job seeker highlights, the job seeker skills and attributes, the job seeker job experience summaries, the job seeker resumes, the job seeker documents, and job seeker biographic data to provide the meaningful insight to the reviewer during the job selection process.

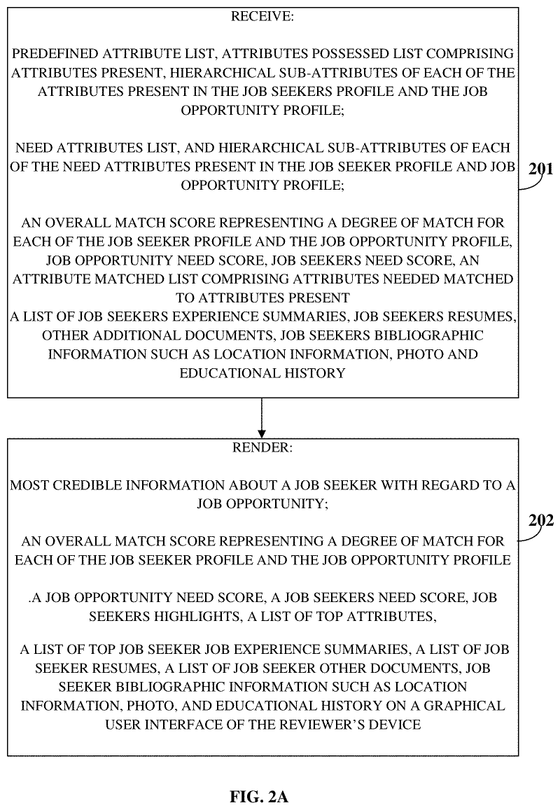

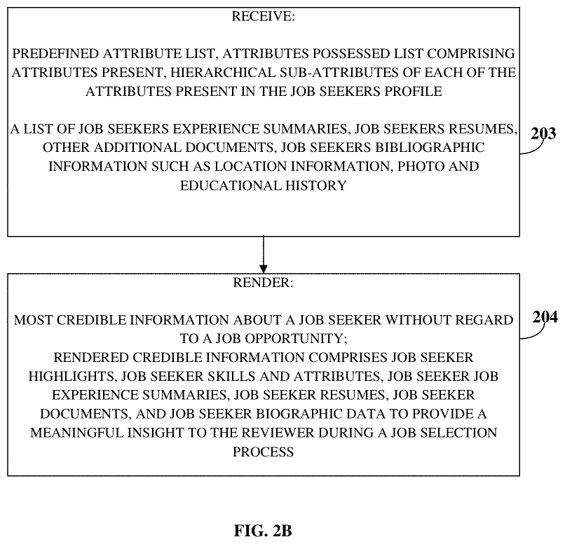

FIG. 2 illustrates a method for displaying the most credible and relevant information about a job seeker with respect to a job opportunity. The method disclosed herein employs a credible and relevant job seeker display system (CARJSDS) 100 incorporating a computer system architecture comprising at least one computer server 101. The computer server 101 comprises at least one database server 102 and at least one processing computer server 106. The database server 102 hosts one or more databases 102a for storing a predefined attribute list, an attributes possessed list, an attributes needed list, a need match attribute list, a job experience summary data, an overall match score representing a degree of match for a job seeker profile and a job opportunity profile, job opportunity need scores, job seeker need score, a list of job seeker job experience summaries linked to the attributes possessed list, resumes, associated documents, and job seeker bibliographic information such as location information, photo, educational history.

The processing computer server 106 is configured to execute the computer program instructions defined by modules of the credible and relevant job seeker display system (CARJSDS) 100 for rendering the most credible and relevant information about a job seeker with respect to a job opportunity, and also for displaying the most credible information about a job seeker without regard to a job opportunity. The credible and relevant information comprises, numerical scores determining a degree of match between a job seeker and a job opportunity, job seeker highlights, job seeker skills and attributes, job seeker job experience summaries, job seeker resumes, job seeker documents, and job seeker biographic data to provide a meaningful insight to the reviewer during a job selection process.

In the method disclosed herein, the credible and relevant job seeker display system (CARJSDS) 100 receives 201 a predefined attribute list, an attributes possessed list comprising attributes present, hierarchical sub-attributes of each of the attributes present in the job seekers profile and job opportunity profiles. The attributes possessed list and the hierarchical sub-attributes of each of the attributes possessed list comprises amount present measures and credibility measures indicating credibility of the corresponding amount present measures. For example, 1000 people may agree that a job seeker, for example, a CAND_1 has a score of 0.9 in MSWord and has a high 1.0 credibility, three people may agree that a CAND_1 has a score of 0.5 in PHP and a credibility of 0.6.

The credible and relevant job seeker display system (CARJSDS) 100 also receives 201 a need attributes list, an attributes needed list comprising attributes needed, hierarchical sub-attributes of each of the attributes needed in the job seeker profile and job opportunity profiles. The attributes need list, and the hierarchical sub-attributes of each of the attributes need list comprises amount needed measures and credibility measures indicating importance of the corresponding amount needed measures. For example, say for an opportunity profile needs, JOB_1, MSWord has a 0.1 importance and PHP has a 0.7 importance.

The credible and relevant job seeker display system (CARJSDS) 100 also receives 201 an overall match score representing a degree of match for each of the job seeker profiles and the job opportunity profiles, job opportunity need scores, job seekers need scores, and an attribute matched list comprising attributes needed matched to attributes present. The attributes matched list and the hierarchical sub-attributes of each of the attributes matched list comprising match scores indicating the degree of match between the attribute needed and the attribute possessed. The credible and the relevant job seeker display system (CARJSDS) 100 also receive 201 a list of job seeker job experience summaries. In an embodiment, the received job seeker job experience summaries are linked to job seeker attributes possessed. The credible and relevant job seeker display system (CARJSDS) 100 also receives 201 job seeker resumes and other additional documents and job seeker bibliographic information such as location information, photo, and educational history. In an embodiment, the received job seeker job experience summaries are linked to resumes.

In an embodiment, the credible and relevant job seeker display system (CARJSDS) 100 renders 202 for a job seeker matched with a job opportunity an overall match score, an opportunity need score, a job seeker need score, job seeker highlights, a list of top attributes, a list of top job seeker job experience summaries, a list of job seeker resumes, a list of job seeker associated documents, job seeker bibliographic information such as location information, photo, and educational history on a graphical user interface of the reviewer's device.

The rendered overall match score represents a degree of match between the job seeker profile and the job opportunity profile. This is a combination of the job opportunity need score and the job seeker need score. The rendered job opportunity need score represents degree of match between the attributes needed, hierarchical sub-attributes of each of the attributes needed by the job opportunity profile with the attributes possessed, hierarchical sub-attributes of each of the attributes possessed by the job seeker profile. The rendered job seeker need score represents the degree of match between the attributes needed, hierarchical sub-attributes of each of the attributes needed by the job seekers profile with the attributes possessed, hierarchical sub-attributes of each of the attributes possessed by the job opportunity profile.

The credible and relevant job seeker display system (CARJSDS) 100 allows the reviewer to click on the rendered job opportunity need score to view the list of matched attributes along with a value present measure, credibility measure arranged in the hierarchy of the need attributes importance measure. In a similar manner, the CARJSDS 100 system displays a list of attributes matched that contributed to the job seekers need score along with a value present measure, credibility measure arranged in the hierarchy of the need attributes importance measure on clicking on the job seeker need score. Thus, when the job seeker is matched with a job opportunity, the rendered list of attributes is the top N attributes from the attributes matched list that most strongly contributed to the job opportunity need score. The match score is shown along with an indication of the score's credibility.

In an embodiment, the credible and relevant job seeker display system (CARJSDS) 100 also provides additional rating link information along with the rendered list of matched attributes when the matched attributes has its value present measure preset through ratings. The rating link information shows ratings information including the number of ratings, individual rating information and identities of the rater who provided the rating information. The CARJSDS 100 also provides individual rating information and identities of the rater who provided the rating information upon authorization.

Thus, when the job seeker is matched with a job opportunity, the job experience summaries are sorted by the job experience summaries whose rated attributes contributed to the job opportunity need score, with job experience plausibility and job experience end date as secondary sorting factors. The CARJSDS 100 system renders a list of the top N job experience summaries along with the plausibility measures and corresponding experience credibility measures. Further, the entire list of job experience summary is displayed as a pop-up or using a link.

The credible and relevant job seeker display system (CARJSDS) 100 system also renders a highlight option displaying a small list of core points to know about the candidate, for example, “John Doe has startup experience as a senior back-end developer for the past 2 years”. In an embodiment, the CARJSDS 100 renders terse phrases representing core points about the candidate.

In an embodiment, the job experience summaries are rendered along with plausibility measures and corresponding experience credibility measures. For example, if John Doe, a software engineer claims experience as a senior back-end developer at a company with a credibility measure of 4.9 and a plausibility score of 4.5. The CARJSDS 100 system renders the job experience summary data of his resume along with the plausibility measures associated with the corresponding job experience summary data. The rating information is weighted by the credibility score assigned to the rater. For example, one candidate, say, CAND_1 may claim to have worked closely with Steve Jobs during his/her employment at Apple, Inc. and have received 0.2 plausibility measures for the claimed job experience summary data. In a similar manner, another candidate, say, for example, CAND_2 may have claimed to work closely with Steve Jobs during his/her employment at Apple, Inc. and have received 1.0 plausibility measures for that claim.

The credible and relevant job seeker display system (CARJSDS) 100 system renders a list of top N job seeker resumes with a button or link to display the entire list of job seeker resumes. The rendered top N job seeker resumes are sorted by those that linked to the most highly sorted job experience summaries, with document date as a secondary sorting factor. The CARJSDS 100 system renders a list of top N job seeker additional documents with a button or link that displays the entire list of the job seeker additional documents. The additional documents are sorted by name, with document date as a secondary sorting factor.

Furthermore, the credible and relevant job seeker display system (CARJSDS) 100 allows associated documents such as resumes, work authorizations, certifications, description of one or more company benefits, etc., to be browsed or downloaded.

Thus, the method and the credible and relevant job seeker display system (CARJSDS) 100 presents the job seekers information with a validated job experience summary and validated skills based approach thereby allowing an easy to quickly scan format in the GUI 101a of the reviewer's device 104. A reviewer might first look at the match score, then for the best candidates they might look at the most important validated skills and attributes, and the most relevant job experiences that contributed to those skills along with a plausibility measure of the job summary data. The most important and validated information is prominent, while the less relevant or unvalidated information will take deeper examination to find.

A first core aspect of the rendered opportunity need match score is to let the reviewer know why a person looking to fill a job opening might want to consider this candidate. Further, a second core aspect of the rendered opportunity match score is to let the reviewer know why the job seeker might want to consider this opportunity. The second core aspect is important as otherwise the reviewer would unnecessarily spend time on the job seekers profile who would refuse the job.

Also, with this method and the credible and relevant job seeker display system (CARJSDS) 100 system, the job seekers do not have to create many different versions of their resumes for different jobs because the same candidate presented for a different job will have a different set of summaries if the different job has different needed skills and attributes, unlike the conventional system where the job seekers has to ideally hand-craft a different resume for every job for which they apply. This method performs automatic recrafting of different job experience summaries and skills present in a single job seeker profile, as a candidate may have one set of skills and job experience summaries presented for jobs needing web developers, and a nearly entirely different set of skills and job experience summaries presented for jobs needing brew masters. Another example for a candidate profile with different job experience summary data could be a software engineer during weekdays and taxi driver during weekends.

FIG. 2A illustrates a method for displaying the most credible and relevant information about a job seeker.

The method disclosed herein employs a credible and relevant job seeker display system 100 incorporating a computer system architecture comprising at least one computer server 101. The computer server 101 comprises at least one database server 102 and at least one processing computer server 106. The database server 102 hosts one or more databases 102a for storing a predefined attribute list, an attributes possessed list, job seeker highlights, a job experience summary data, a list of job seeker job experience summaries linked to the attributes possessed list, resumes, associated documents, and job seeker bibliographic information such as location information, photo and educational history.

As exemplarily illustrated in FIG. 2A, the credible and relevant job seeker display system (CARJSDS) 100 receives 203 a predefined attribute list, an attributes possessed list comprising attributes present, hierarchical sub-attributes of each of the attributes present in the job seekers profile. The attributes possessed list and the hierarchical sub-attributes of each of the attributes possessed list comprises amount present measures and credibility measures indicating credibility of the corresponding amount present measures.

The credible and relevant job seeker display system (CARJSDS) 100 also receives 203 a list of job seeker job experience summaries, job seeker skills and attributes, job seeker bibliographic information such as location information, photo, educational history, job seeker resumes and other additional documents. In an embodiment, the received job experience summaries are linked to job seeker attributes possessed.

The credible and relevant job seeker display system (CARJSDS) 100 renders 204 the most credible information about a job seeker without regard to a job opportunity. The rendered credible information comprises job seeker highlights, job seeker skills and attributes, job seeker job experience summaries, job seeker resumes, job seeker documents, and job seeker biographic data to provide a meaningful insight to the reviewer during a job selection process. In an embodiment, the CARJSDS 100 renders a list of top N attributes with the highest credibility weighted amount present measure from the job seeker's attributes possessed list. In a similar manner, the CARJSDS 100 system renders job experience summaries sorted by job experience plausibility and job experience end date.

The credible and relevant job seeker display system (CARJSDS) 100 system renders a list of top N job seeker resumes with a button or link to display the entire list of job seeker resumes. The rendered top N job seeker resumes are sorted by those that are linked to the most highly sorted job experience summaries, with document date as a secondary sorting factor. The CARJSDS 100 system renders a list of top N job seeker additional documents with a button or link that causes to display the entire list of the job seeker additional documents. The additional documents are sorted by name, with document date as a secondary sorting factor. Further, the credible and relevant job seeker display system (CARJSDS) 100 allows associated documents such as resumes, work authorizations, certifications, description of one or more company benefits, etc., to be browsed or downloaded.

With this method and CARJSDS 100 system, reviewers are presented with the most credible and the relevant information without having to shift through the resume themselves. The rendered attributes are also presented with corresponding credibility and plausibility assessments that can guide the reviewers decisions of what claims to accept at face value and what claims to validate before hiring.

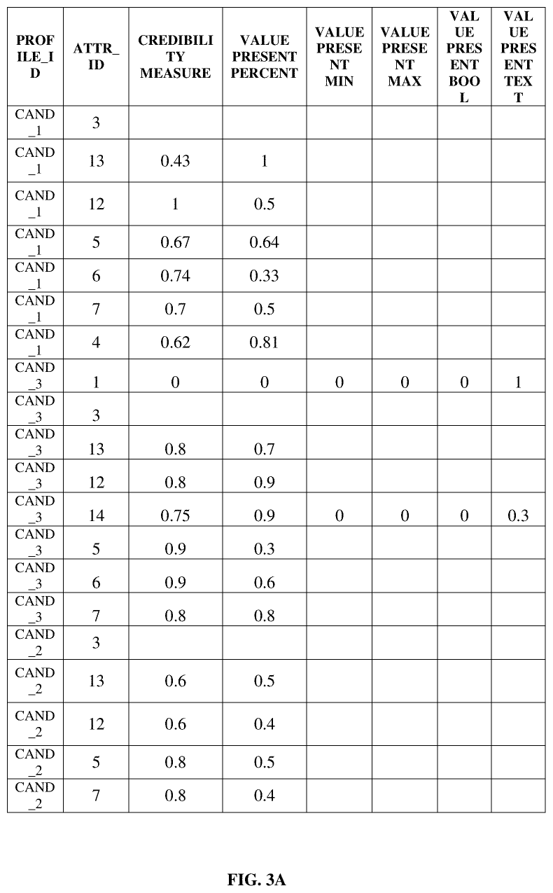

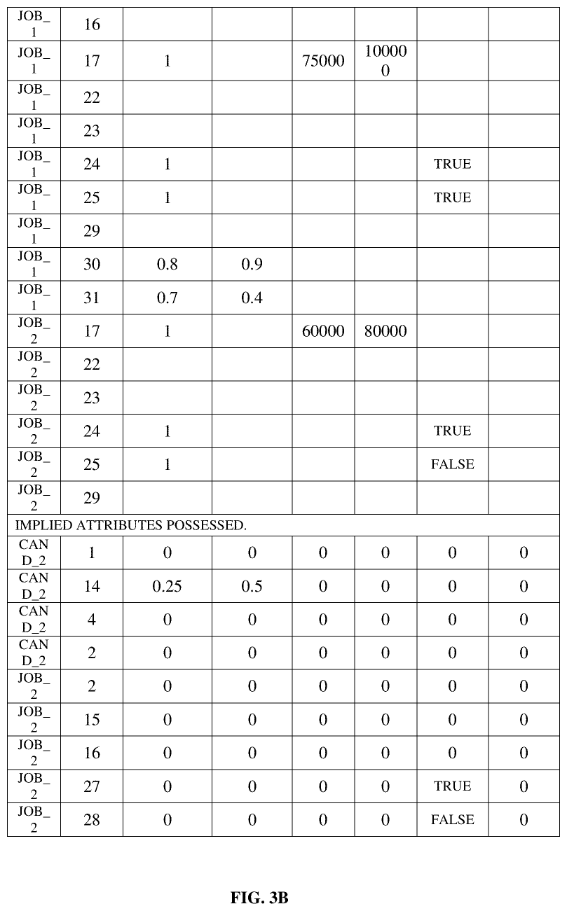

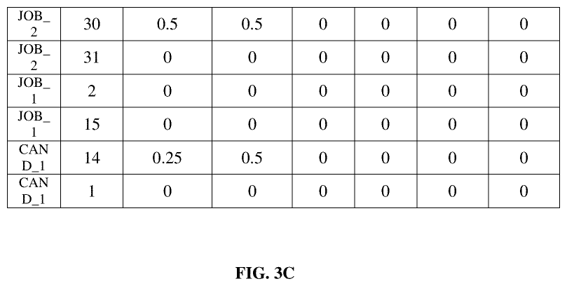

FIGS. 3A-3C exemplarily illustrate an attributes possessed list comprising attributes possessed in the item profiles CAND_1, CAND_2, and CAND_3, JOB_1 and JOB_2 with corresponding value present measures and credibility measures. The attributes possessed by the job seekers profiles are all skills. The attributes possessed by JOB_1, and JOB_2 are all ranges or Booleans with full credibility. In an embodiment, the attributes possessed by CAND_1, CAND_2, and CAND_3 do not have less than 1 credibility, and the attributes possessed by JOB_1 and JOB_2 do not have full credibility. On observation of the value present measures in JOB_1 and JOB_2, it is found that JOB_2 pays less, does not have healthcare for spouse, and has people that are not as nice. Also, on comparing the items CAND_1 and CAND_2, CAND_1 has lower overall skills and core traits.

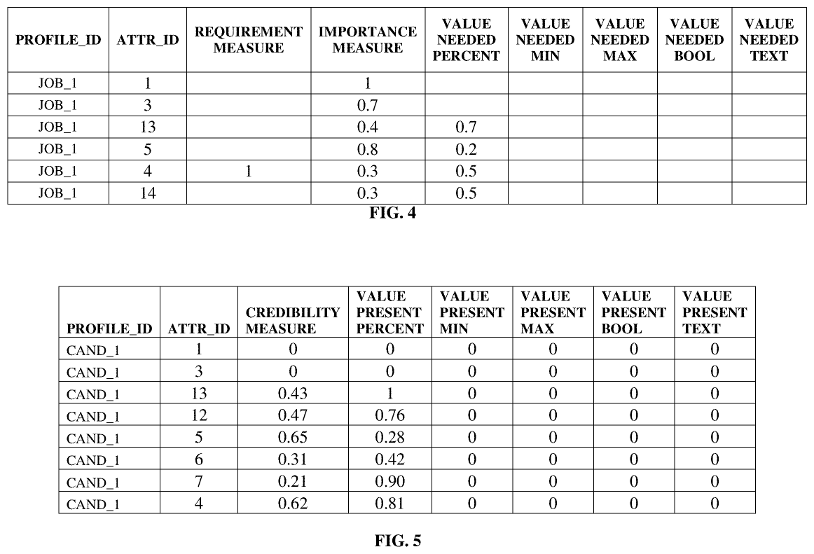

FIG. 4 exemplarily illustrates an attributes needed list comprising attributes needed in the JOB profile JOB_1 with corresponding requirement measures, attribute importance measures, and value needed measures. As exemplarily illustrated, the attribute with ATTR_ID 3 has a PARENTATTR_ID 1. The attributes with ATTR_ID 13, 4, 5, and 14 are sub-attributes of the parent attribute with ATTR_ID 3.

FIG. 5 exemplarily illustrates the attributes possessed list comprising attributes possessed by the CAND_1, with corresponding value present measures and credibility measure. As exemplarily illustrated in FIG. 4, the attribute with ATTR_ID 3 has a PARENTATTR_ID 1. The attributes with ATTR_ID 13, 4, 5, and 14 are sub-attributes of the parent attribute with ATTR_ID 3.

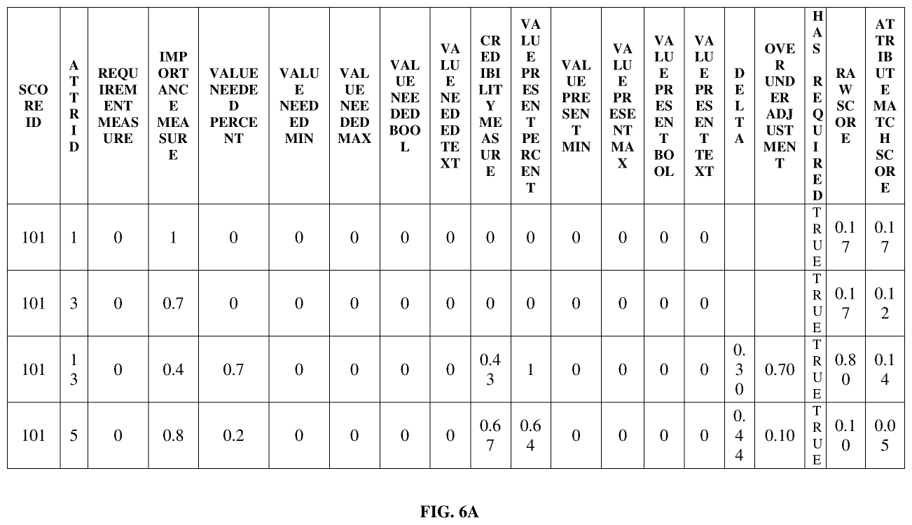

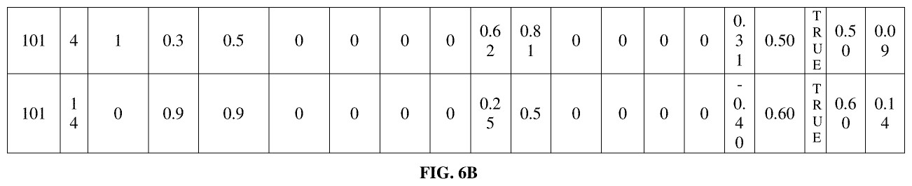

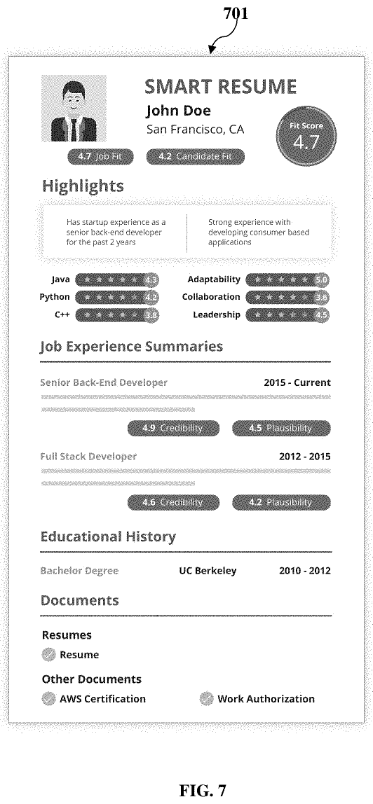

FIGS. 6A and 6B exemplarily illustrate a matched attribute list created by the CARJSDS 100 system by matching the attributes possessed in the attributes possessed list with the attributes needed in the attributes needed list.

The different data types of the attributes are percentage, range, Boolean, and text. The value needed measures and the value present measures are expressed as percent, Booleans, range, and text. An example of the value needed measure in Boolean is a response to “must be free of TB” and the value present measure in Boolean is a response to “are you free of TB”. Also, a credibility measure is associated with the value present measure. For example, multiple parties supply a response to a question about a need similar to multiple parties rating PHP skills of a candidate and 3 responses are TRUE and 5 responses are FALSE. However, the responses of the party that supplied TRUE may have a higher credibility. In such cases, the result of merging of the multi-valued Boolean would be a Boolean with some uncertainty.

FIG. 7 exemplarily illustrates a screenshot of a graphical user interface 101a rendered on a reviewer's device 104 by the credible and relevant job seeker display system (CARJSDS) 100.

As exemplarily illustrated in FIG. 7, the credible and relevant job seeker display system (CARJSDS) 100 system renders the most credible and relevant information 701 about a job seeker with respect to a job opportunity. In an embodiment, the CARJSDS 100 system renders an overall match score, an opportunity need score, a job seeker need score, job seeker highlights, a list of top attributes, a list of top job seeker job experience summaries, a list of job seeker resumes, a list of job seeker associated documents, job seeker bibliographic information such as location information, photo, and educational history on a graphical user interface 701 of the reviewer's device 104.

The rendered overall match score, for example, a fit score of 4.7 represents the degree of match between the job seeker profile, for example, Candidate John Doe, and the job opportunity profile, for example, JOB. This is a combination of the job opportunity need score, for example, a JOB Fit score of 4.7, and the job seeker's need score, for example, a Candidate Fit score of 4.2. The rendered job opportunity need score, for example, a JOB Fit score of 4.7 represents the degree of match between the attributes needed, hierarchical sub-attributes of each of the attributes needed by the job opportunity profile, say, for example, JOB with the attributes possessed, hierarchical sub-attributes of each of the attributes possessed by the job seekers profile, for example, Candidate. The rendered job seekers need score, for example, a Candidate Fit score of 4.2 represents the degree of match between the attributes needed, hierarchical sub-attributes of each of the attributes needed by the job seekers profiles, for example, JOB with the attributes possessed, hierarchical sub-attributes of each of the attributes possessed by the opportunity profile, for example, Candidate.

The credible and relevant job seeker display system (CARJSDS) 100 allows the reviewer to click on the rendered job opportunity need score, for example, the JOB Fit score of 4.7 to view the list of matched attributes along with a value present measure, credibility measure arranged in the hierarchy of the need attributes importance measure. In a similar manner, the CARJSDS 100 system displays a list of attributes matched that contributed to the job seekers need score, for example, a Candidate Fit score of 4.2 along with a value present measure, credibility measure arranged in the hierarchy of the need attributes importance measure on clicking on the job seeker's need score.

The credible and relevant job seeker display system (CARJSDS) 100 system also renders a highlight option displaying a small list of core points to know about the candidate, for example, “John Doe has startup experience as a senior back-end developer for the past 2 years”. In an embodiment, the CARJSDS 100 renders terse phrases representing core points about the candidate.

The CARJSDS 100 system arranges the rendered skills with the degree of importance with which the skill/attribute possessed is matched to the skill/attribute needed by using a pop-up, a color change or a font change.

The CARJSDS 100 system renders a list of the top N job experience summaries along with plausibility measures and corresponding experience credibility measures. For example, the CARJSDS 100 system renders the top N job experience summaries of the Candidate, John Doe, as John Doe has worked as a full stack developer for the period 2012-2015 with a credibility measure of 4.9 and a plausibility measure of 4.5, and as a senior back-end developer for the period 2015 till current date with a credibility measure of 4.6 and a plausibility measure of 4.2. Further, the entire list of job experience summary is displayed as a pop-up or by clicking on the displayed job experience summaries, say, for example, senior back end developer experience summary or full stack developer experience summary. Thus, when the job seeker, say, for example, Candidate is matched with a job opportunity, say, for example, JOB, the job experience summaries are sorted by rated attributes that contributed to the job opportunity need score, with job experience plausibility and job experience end date as secondary sorting factors. The CARJSDS 100 system also allows the reviewer to drill into the skills the CARJSDS 100 system considers the job summary experience would have contributed. The CARJSDS 100 also renders resumes which in some cases are linked to job experience summaries.

The CARJSDS 100 system also renders job seekers bibliographic information such as location information, photo, educational history, resume and other additional documents submitted by the job seeker, for example, work authorization certificates apart from the resume.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor or a similar device. In different embodiments, the “non-transitory computer readable storage media” further refers to a single medium or multiple media, for example, a centralized database, a distributed database, and/or associated caches and servers that store one or more sets of instructions that are read by a computer, a processor or a similar device. The “non-transitory computer readable storage media” further refers to any medium capable of storing or encoding a set of instructions for execution by a computer, a processor or a similar device and that causes a computer, a processor or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Peri®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the computer implemented method and the credible and relevant job seeker display system 200 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the computer implemented method and the credible and relevant job seeker display system (CARJSDS) 100 disclosed herein are implemented as programmed elements, or non-programmed elements, or any suitable combination thereof.

Where databases 102a are described such as the database server 102, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the credible and relevant job seeker display system (CARJSDS) 100, the databases are integrated to communicate with each other for enabling simultaneous updates of data linked across the databases, when there are any updates to the data in one of the databases.

The computer implemented method and the credible and relevant job seeker display system (CARJSDS) 100 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The computer implemented method and the credible and relevant job seeker display system (CARJSDS) 100 disclosed herein are not limited to a particular computer system platform, processor, operating system, or network. In an embodiment, one or more aspects of the computer implemented method and the credible and relevant job seeker display system (CARJSDS) 100 disclosed herein are distributed among one or more computer systems, for example, servers configured to provide one or more services to one or more client computers, or to perform a complete task in a distributed system. For example, one or more aspects of the computer implemented method and the credible and relevant job seeker display system (CARJSDS) 100 disclosed herein are performed on a client-server system that comprises components distributed among one or more server systems that perform multiple functions according to various embodiments. These components comprise, for example, executable, intermediate, or interpreted code, which communicate over a network using a communication protocol. The computer implemented method and the credible and relevant job seeker display system (CARJSDS) 100 disclosed herein are not limited to be executable on any particular system or group of systems, and are not limited to any particular distributed architecture, network, or communication protocol.

The foregoing examples have been provided merely for explanation and are in no way to be construed as limiting of the method and the credible and relevant job seeker display system (CARJSDS) 100 disclosed herein. While the method and the credible and relevant job seeker display system (CARJSDS) 100 have been described with reference to various embodiments, it is understood that the words, which have been used herein, are words of description and illustration, rather than words of limitation. Furthermore, although the method and the credible and relevant job seeker display system (CARJSDS) 100 have been described herein with reference to particular means, materials, and embodiments, the method and the credible and relevant job seeker display system (CARJSDS) 100 are not intended to be limited to the particulars disclosed herein; rather, the method and credible and relevant job seeker display system (CARJSDS) 100 extend to all functionally equivalent structures, methods and uses, such as are within the scope of the appended claims. While multiple embodiments are disclosed, it will be understood by those skilled in the art, having the benefit of the teachings of this specification, that the method and the credible and relevant job seeker display system (CARJSDS) 100 disclosed herein are capable of modifications and other embodiments may be effected and changes may be made thereto, without departing from the scope and spirit of the method and the credible and relevant job seeker display system (CARJSDS) 100 disclosed herein.

We claim:

1. A credible and relevant job seeker display system comprising:
at least one computer server for rendering a credible and relevant information about a job seeker with respect to a job opportunity, said at least one computer server of said credible and relevant job seeker display system comprising:
at least one database server hosting one or more databases for storing a predefined attribute list, an attributes possessed list, an attributes needed list, a need match attribute list, a job experience summary data, an overall match score representing a degree of match for a job seeker profile and a job opportunity profile, job opportunity need scores, job seeker need score, a list of job seeker job experience summaries linked to said attributes possessed list, one or more job seeker resumes, one or more job seeker associated documents, and job seeker bibliographic information comprising one or more of location information, photo, and educational history; and
at least one processing computer server comprising at least one processor communicatively coupled to said at least one database server via a network, said at least one processor configured to execute said computer program instructions defined by modules of said credible and relevant job seeker display system, said modules of said credible and relevant job seeker display system comprising:
a first predefined attribute list receiving module for receiving said predefined attribute list, said attributes possessed list comprising attributes present, hierarchical sub-attributes of each of said attributes present in said job seekers profiles and job opportunity profiles;
a needs attributes list receiving module for receiving said need attributes list comprising attributes needed, hierarchical sub-attributes of each of said attributes needed in said job seeker profile and job opportunity profiles;
an overall match score receiving module for receiving said overall match score representing said degree of match for each of said job seeker profiles and said job opportunity profiles, said job opportunity need scores, said job seekers need scores, and an attribute matched list comprising attributes needed matched to attributes present;
a first list receiving module for receiving said list of job seeker job experience summaries, said one or more job seeker resumes, one or more job seeker associated documents, and job seeker bibliographic information comprising one or more of said location information, said photo, and said educational history;
a first rendering module for rendering said most credible and relevant information about said job seeker with respect to said job opportunity, for said job seeker matched with said job opportunity, said first rendering module further comprises:
a job opportunity need score rendering module for rendering said job opportunity need score representing degree of match between said attributes needed, hierarchical sub-attributes of each of said attributes needed by said job opportunity profile with said attributes possessed, hierarchical sub-attributes of each of said attributes possessed by said job seeker profile;
a job seeker need score rendering module for rendering said job seeker need score representing said degree of match between said attributes needed, hierarchical sub-attributes of each of said attributes needed by said job seekers profile with said attributes possessed, hierarchical sub-attributes of each of said attributes possessed by said job opportunity profile;
an attribute rendering module for rendering a list of top N attributes from said attributes matched list that most strongly contributed to said job opportunity need score;
a job experience summary rendering module for rendering a list of top job experience summaries whose rated attributes contributed to said job opportunity need score;
a highlight option rendering module for automatically rendering a highlight option displaying a list of core points about a candidate; and
a list rendering module for rendering a list of said one or more job seeker resumes, a list of said one or more job seeker associated documents, and said job seeker bibliographic information comprising one or more of said location information, said photo, and said educational history on said graphical user interface of said reviewer's device to provide a meaningful insight to said reviewer during a job selection process.

2. The credible and relevant job seeker display system of claim 1 further comprising:
a second predefined attribute list receiving module for receiving said predefined attribute list, said attributes possessed list comprising attributes present, hierarchical sub-attributes of each of said attributes present in said job seekers profile;
a second list receiving module for receiving said list of job seeker job experience summaries, said job seeker skills and attributes, said job seeker resumes, and said one or more job seeker associated documents, said job seeker bibliographic information such as location information, photo and educational history; and
a second rendering module for rendering said most credible information about said job seeker without regard to said job opportunity comprising, said job seeker highlights, said job seeker skills and attributes, said job seeker job experience summaries, said job seeker resumes, said one or more job seeker associated documents, and job seeker biographic data to provide said meaningful insight to said reviewer during said job selection process.

3. The credible and relevant job seeker display system of claim 1, wherein said first predefined attribute list receiving module further comprises amount present measures and credibility measures indicating credibility of the corresponding amount present measures.

4. The credible and relevant job seeker display system of claim 1, wherein said needs attributes list receiving module further comprises amount needed measures and credibility measures indicating importance of the corresponding amount needed measures.

5. The credible and relevant job seeker display system of claim 1, further comprises a rating link provider for providing an additional rating link information along with the rendered list of matched attributes when the matched attributes has its value present measure preset through ratings, wherein the rating link information comprises number of ratings, individual rating information and identities of the rater who provided the rating information.

6. A method employing a credible and relevant job seeker display system comprising at least one processor, said method comprising:
receiving a predefined attribute list, a attributes possessed list comprising attributes present, hierarchical sub-attributes of each of said attributes present in said job seekers profiles and job opportunity profiles;
receiving a need attributes list comprising attributes needed, hierarchical sub-attributes of each of said attributes needed in said job seeker profile and said job opportunity profiles;
receiving an overall match score representing a degree of match for each of said job seeker profiles and said job opportunity profiles, job opportunity need scores, job seekers need scores, and an attribute matched list comprising said attributes needed matched to said attributes present;
receiving said list of job seeker job experience summaries, job seeker resumes, one or more job seeker associated documents, and job seeker bibliographic information comprising one or more of location information, photo, and educational history;
rendering most credible and relevant information about said job seeker with respect to a job opportunity, for said job seeker matched with said job opportunity;
rendering said job opportunity need score representing degree of match between said attributes needed, hierarchical sub-attributes of each of said attributes needed by said job opportunity profile with said attributes possessed, hierarchical sub-attributes of each of said attributes possessed by said job seeker profile;
rendering said job seeker need score representing said degree of match between said attributes needed, hierarchical sub-attributes of each of said attributes needed by said job seekers profile with said attributes possessed, hierarchical sub-attributes of each of said attributes possessed by said job opportunity profile;
rendering a list of top N attributes from said attributes matched list that most strongly contributed to said job opportunity need score;
rendering a list of top job experience summaries whose rated attributes contributed to said job opportunity need score;
rendering a highlight option for automatically displaying a list of core points to know about a candidate; and
rendering a list of said one or more job seeker resumes, a list of said one or more job seeker associated documents, and said job seeker bibliographic information comprising one or more of said location information, photo, and educational history on said graphical user interface of said reviewer's device to provide a meaningful insight to said reviewer during a job selection process.

7. The method of claim 6, further comprising:
receiving said predefined attribute list, said attributes possessed list comprising attributes present, hierarchical sub-attributes of each of said attributes present in said job seekers profile;
receiving said list of job seeker job experience summaries, said job seeker skills and attributes, said job seeker resumes and job seeker other documents, said job seeker bibliographic information such as location information, photo and educational history; and
rendering said most credible information about said job seeker without regard to said job opportunity comprising said job seeker highlights, said job seeker skills and attributes, said job seeker job experience summaries, said job seeker resumes, said job seeker documents, and job seeker biographic data to provide said meaningful insight to said reviewer during said job selection process.

8. The method of claim 6, wherein the attributes possessed list and the hierarchical sub-attributes of each of the attributes possessed list further comprises amount present measures and credibility measures indicating credibility of the corresponding amount present measures.

9. The method of claim 6, wherein the attributes need list, and the hierarchical sub-attributes of each of the attributes need list further comprises amount needed measures and credibility measures indicating importance of the corresponding amount needed measures.

10. The method of claim 6, further provides an additional rating link information along with the rendered list of matched attributes when the matched attributes has its value present measure preset through ratings, wherein the rating link information comprises number of ratings, individual rating information and identities of the rater who provided the rating information.

11. The method of claim 6, further performs automatic recrafting of different job experience summaries and skills present in a single job seeker profile.

12. A non-transitory computer readable storage medium having embodied thereon, computer program codes comprising instructions executable by at least one processor, said computer program codes comprising:
a first computer program code for receiving a predefined attribute list, a attributes possessed list comprising attributes present, hierarchical sub-attributes of each of said attributes present in said job seekers profiles and job opportunity profiles;
a second computer program code for receiving a need attributes list comprising attributes needed, hierarchical sub-attributes of each of said attributes needed in said job seeker profile and said job opportunity profiles;
a third computer program code for receiving an overall match score representing a degree of match for each of said job seeker profiles and said job opportunity profiles, job opportunity need scores, job seekers need scores, and an attribute matched list comprising said attributes needed matched to said attributes present;
a fourth computer program code for receiving said list of job seeker job experience summaries, job seeker resumes, one or more job seeker associated documents, and job seeker bibliographic information comprising one or more of location information, photo, and educational history;
a fifth computer program code for rendering most credible and relevant information about said job seeker with respect to a job opportunity, for said job seeker matched with said job opportunity;
a sixth computer program code for rendering said job opportunity need score representing degree of match between said attributes needed, hierarchical sub-attributes of each of said attributes needed by said job opportunity profile with said attributes possessed, hierarchical sub-attributes of each of said attributes possessed by said job seeker profile;
an seventh computer program code for rendering said job seeker need score representing said degree of match between said attributes needed, hierarchical sub-attributes of each of said attributes needed by said job seekers profile with said attributes possessed, hierarchical sub-attributes of each of said attributes possessed by said job opportunity profile;
an eighth computer program code for rendering a list of top N attributes from said attributes matched list that most strongly contributed to said job opportunity need score;
a ninth computer program code for rendering a list of top job experience summaries whose rated attributes contributed to said job opportunity need score;
a tenth computer program code for rendering a highlight option for automatically displaying a list of core points to know about a candidate; and
an eleventh computer program code for rendering a list of said one or more job seeker resumes, a list of said one or more job seeker associated documents, and said job seeker bibliographic information comprising one or more of said location information, photo, and educational history on said graphical user interface of a reviewer's device to provide a meaningful insight to said reviewer during a job selection process.

13. The non-transitory computer readable storage medium of claim 12, further comprising:
a twelfth computer program code for receiving said predefined attribute list, said attributes possessed list comprising attributes present, hierarchical sub-attributes of each of said attributes present in said job seekers profile;
a thirteenth computer program code for receiving said list of job seeker job experience summaries, said job seeker skills and attributes, said job seeker resumes and job seeker other documents, said job seeker bibliographic information such as location information, photo and educational history; and
a fourteenth computer program code for rendering said most credible information about said job seeker without regard to said job opportunity comprising said job seeker highlights, said job seeker skills and attributes, said job seeker job experience summaries, said job seeker resumes, said job seeker documents, and job seeker biographic data to provide said meaningful insight to said reviewer during said job selection process.
